(19) United States
(12) Patent Application Publication
(10) Pub. No.: US 2022/0357709 A1
(43) Pub. Date: Nov. 10, 2022

(54) SYSTEM AND METHOD FOR LEGALLY COMPLIANT DOCUMENTATION OF HEALTH AND SAFETY-RELATED PROCESS EVENTS

(71) Applicant: Francotyp-Postalia GmbH, Berlin (DE)

(72) Inventors: Uwe Hübler, Neuenhagen (DE); Clemens Heinrich, Oranienburg (DE); Stephan Günther, Glienicke (DE)

(73) Assignee: Francotyp-Postalia GmbH, Berlin (DE)

(21) Appl. No.: 17/737,188

(22) Filed: May 5, 2022

(30) Foreign Application Priority Data
May 7, 2021 (DE) 102021111934.0

(51) Int. Cl. G05B 13/02; G05B 19/4063

(52) U.S. Cl. CPC G05B 13/021; G05B 19/4063; G05B 2219/32015

(57) ABSTRACT

The invention relates to a system and a method for legally compliant documentation of health-relevant and safety-relevant process events in a food processing plant. The system comprises a workstation, an acquisition device, an auditor device, a report generator and a signing device. The acquisition device is assigned to the workstation and is configured to automatically acquire plant-related process variables. The auditor device, on the other hand, is configured to analyze the acquired process variables and identify a trigger event. Further, the auditor device is capable of generating a first data set including at least one of the acquired process variables and/or an information value about the trigger event. The report generator is adapted to determine a signing device responsible for the first data set. In addition, the report generator may generate a requirement data set comprising a signature requirement and at least part of the first data set. This requirement data set may be transmitted to the responsible signing device. The signing device is adapted to generate a requirement data set comprising an electronic signature for at least part of the requirement data set.

The invention relates to a system and a method for legally compliant documentation of health and safety-relevant process events in a food processing plant. The system comprises a workstation, an acquisition device, an auditor device, a report generator and a signing device. The acquisition device is assigned to the workstation and is adapted to automatically acquire plant-related process variables. The auditor device, on the other hand, is configured to analyze the acquired process variables and identify a trigger event. Furthermore, the auditor device is able to generate a first data set comprising the acquired process variables and/or an information value about the trigger event. The auditor device is capable of transmitting this data set to the report generator. The report generator, in turn, is adapted to determine a signing device responsible for the first data set. Further, the report generator may generate a request data set comprising a signature request and at least part of the first data set. This request data set may be transmitted to the responsible signing device. The signing device is adapted to generate a response data set comprising an electronic signature for at least part of the request data set.

### BACKGROUND AND PRIOR ART

Process and plant control via the Internet is well known in the prior art. So-called IoT systems (Internet of Things) make it possible for a user to monitor and control processes and plants remotely on the basis of their operating and status parameters.

However, it is currently very time-consuming and cost-intensive to generate clearly defined, legally compliant documentation of the information and troubleshooting actions required in each case when malfunctions or exceptional states occur, as well as unexpected events that may affect an IoT system. There is therefore a great need for a solution to remedy this shortcoming.

Particularly in food processing plants, there are a large number of different health-relevant and thus safety-relevant processes that must be monitored and documented. For example, all processes around food delivery, storage, processing and disposal are affected. Furthermore, hygiene processes must also be monitored, such as cleaning cycles for sanitary facilities, disinfection measures for employees, and clothing protection measures.

The automated acquisition of individual process variables such as cooling or cooking temperatures via sensors, cleaning cycles or disinfection processes via near-field communication (NFC on RFID basis) or also access monitoring with the aid of chip card reading of individual workstations are known in the prior art. For example, there are (“smart”) refrigerators that can acquire cooling temperatures and load situations.

However, there is no system and/or method that centrally processes the acquired parameters of individual workstations in a food processing plant, analyzes them automatically and, in particular, ensures automatic, legally compliant forwarding of information to responsible persons/bodies in the event of critical process parameters being exceeded or not being met, so that these bodies/persons can react accordingly and afterwards the flow of information is clearly documented in terms of time and content.

### Objective of the Invention

The objective of the invention was therefore to eliminate the disadvantages of the prior art and to provide a cost-effective and automated system and method for legally compliant documentation of health-relevant and safety-relevant process events in a food processing plant.

### SUMMARY OF THE INVENTION

The objective according to the invention is solved by the features of the independent claims. Advantageous embodiments of the invention are described in the dependent claims.

In a preferred embodiment, the invention relates to a system for legally compliant documentation of health-relevant and safety-relevant process events in a food processing plant, the system comprising at least one workstation, an acquisition device, an auditor device, a report generator and a signing device, characterized in that
a) the acquisition device is assigned to the workstation and is adapted to automatically acquire plant-related process variables;
b) the auditor device is adapted to,
   (i) analyze the acquired process variables and identify a trigger event;
   (ii) generate a first data set, the first data set comprising at least one of the acquired process variables and/or an information value about the trigger event;
   (iii) transmit the first data set to the report generator;
c) the report generator is adapted to
   (i) determine a signing device responsible for the first data set, the responsible signing device being determined on the basis of the information value comprised in the data set concerning the trigger event and/or on the basis of a process variable comprised in the first data set and/or on the basis of an evaluation of the information values and/or process variables obtained;
   (ii) transmit a request data set to the signing device assigned to the first data set, the request data set comprising a signature request and at least part of the first data set;
d) the signing device is adapted to
   (i) generate a response data set that comprises an electronic signature over at least part of the request data set.

Such a system for solving the above-mentioned objective is neither known from the prior art nor suggested to an average person skilled in the art. Rather, the system according to the invention is to be regarded as a departure from the prior art, in which in particular individual workstations or their acquired process variables are subjected exclusively to individual consideration and manual monitoring, analysis, transmission and/or processing steps must frequently be included. Whereas the system according to the invention offers the possibility to provide a fully automatically executed system for legally compliant documentation—starting from the acquisition of process variables up to the transmission of relevant process information to a responsible entity, for example persons or other bodies. Above all, the system also offers the possibility of providing particularly secure (in terms of manipulation) documentation of health-relevant and safety-relevant process events.

Advantageously, the system according to the invention makes it possible to derive error sources on the basis of existing process information and thus to create possibilities for their elimination. In addition to normal status reports, it is particularly advantageous that relevant process events, e.g. deviations from defined specifications such as minimum cooking temperatures or maximum storage temperatures or even failure to comply with specified cleaning cycles, can be automatically reported to defined persons/bodies via the digital signature method and system according to the invention with a tamper-proof time stamp and acknowledged with a legally compliant digital signature. This means that it is still possible to trace at any time what type of deviations or failures occurred at what time and which persons were informed about them. In this way, both root cause analysis and troubleshooting are significantly simplified and any existing process defects or acute failures can be rectified. The signature requirements can be linked to process contents or to the type of process deviations, so that, for example, the personnel department of a company is also informed of violations of access rules by persons in the system and/or workstation according to the invention, in addition to an occupational safety officer.

Within the meaning of the invention, a food processing plant is preferably understood to mean a kitchen, in particular a commercial kitchen, the plant preferably having at least one workstation, more preferably a plurality of workstations. It is understood that the general term “kitchen” also includes small kitchens for private households.

A commercial kitchen, on the other hand, is preferably a larger kitchen for commercial use, primarily in the catering industry and communal catering (hospital kitchen, factory kitchen, cafeteria). It can be designed, for example, as a large-scale kitchen of a hotel or a canteen, in which regular meals are cooked for a large number of people, or as a company that prepares and delivers meals for bulk buyers (catering). Preferably, at least 10-250 meals, more preferably at least 25-150 meals and in particular at least 50-100 meals are prepared daily in a commercial kitchen and these are either served on site or delivered to other serving points.

Furthermore, a food processing plant may preferably also be understood as a plant in the food industry. For example, such a plant may be designed as a butchers shop, bakery or as a plant for the production of ready meals (convenience products), brewery, winery or as a plant for the production of primary materials, raw materials or additives, supplements or refining substances as preliminary stages for food production.

In a preferred embodiment, a workstation is an apparatus adapted to perform a plant-related process. This process may be dedicated to the transportation of food in the context of processing, handling, modification, storage. On the other hand, in an alternative embodiment, the workstation is preferably adapted to carry out processes in the context of hygiene and cleaning.

It is preferred within the meaning of the invention that the acquisition device comprises at least one sensor or sensor system. A sensor can determine physical (e.g., amount of heat, temperature, humidity, pressure, sound field quantities, brightness, acceleration) or chemical (e.g., pH, ionic strength, electrochemical potential, analytical methods such as spectral or microbiological) properties and/or the material composition of its environment qualitatively or quantitatively as a measured variable. These quantities are acquired by means of physical or chemical effects and converted into an electrical signal that can be further processed. In a preferred embodiment, the acquisition device comprises a sensor selected from the group comprising: temperature sensor, displacement sensor, pressure sensor (force sensor), acceleration sensor, image sensor, touch sensor, humidity sensor, GPS sensor, NFC sensor, RFID sensor, analysis sensor, air quality sensor.

The sensors of the acquisition device are adapted to automatically acquire plant-related process variables, which preferably comprise status information of the food to be processed and of the workstation and/or operating information of the workstation. The combination of all information preferably results in a comprehensive overall information, from which in particular very detailed knowledge can be obtained about the food processing plant as well as its comprised components or workstations and the food to be processed.

In accordance with the invention, the acquisition device can also be divided into a plurality of acquisition devices, wherein the respective acquisition devices comprise different sensors. In a preferred embodiment, the acquisition device comprises a memory and a processor. This allows the acquisition device to pre-process the acquired information. This may, for example, comprise an initial analysis or filtering of the acquired data, as a result of which the auditor device advantageously requires less power for data processing as well as memory.

It is further preferred that the acquisition device is assigned to the workstation. In this case, the acquisition device can be arranged together with the workstation as a station in the system, i.e. preferably the acquisition device can be integrated into the work station. However, the acquisition device can also be arranged separately from the workstation, for example as a portable device, and can be assigned to a workstation as required. If the acquisition device and the workstation are to be regarded as one unit in a station/device, this advantageously results in the acquisition device enabling improved accuracy, reproducibility of the measured values, whereby regular recalibration of the acquisition device can be avoided, since it is preferably arranged in a fixed position in relation to the workstation. If, on the other hand, the workstation is arranged independently of the acquisition device (the workstations and the acquisition device are respectively to be regarded as independent devices), a variable assignment of an acquisition device to a work station is advantageously made possible in a simple manner, so that the acquisition device can be used in different workstations respectively for different purposes. For example, a temperature sensor may measure a cooking temperature in an oven for a predetermined time, and in another context for monitoring process events, the temperature sensor may acquire a cooling temperature in a refrigeration room for a predetermined time.

The auditor device according to the invention is preferably to be seen as a data processing unit. It preferably comprises means for generating, processing, storing, transmitting and receiving data. The auditor device is preferably in data communication with the acquisition device and the report generator, whereby data can be transferred between these system components. The auditor device may also be adapted as a physical unit with the workstation and the acquisition device, which advantageously minimizes the possibility of external intervention in and manipulation of the system. In a preferred embodiment, the auditor device executes algorithms and calculations by receiving input data from the acquisition devices and, after execution of the algorithms, generates output data that is preferably transmitted to the report generator. The advantage of such an arrangement is that the acquisition device does not need to be equipped with components for data processing (processor) and data storage. Another advantage is that the auditor device can include a variety of acquired data from different acquisition devices for its analysis or execution of the algorithms, so that a wide-ranging analysis is possible. If, for example, the required flour becomes scarce in a first processing station (workstation 1)—which is acquired by an associated acquisition device (acquisition device 1)—the auditor device can automatically identify that there is a quality deficiency of the newly delivered flour in a further input inspection station (workstation 2) by means of acquired process variables of a further acquisition device (acquisition device 2) and can consequently cause reserve flour to be supplied to the process in good time from the deep-freeze of a storage facility (workstation 3).

Based on the acquired process variables, the auditor device can identify a trigger event. Within the meaning of the invention, a trigger event is preferably to be understood as an event that represents a discrepancy between an actual event and an event that is actually expected and/or planned, such that a notification to responsible entities (persons or bodies) and/or an action is required. Preferably, a trigger event is also to be understood as a “trigger”. A trigger event may also preferably be time-dependent, such that, for example, certain acquired process parameters may reach responsible entities (bodies/persons) as “milestones” at different time intervals. For example, a trigger event can be an exceedance of or failure to reach a temperature threshold, exhausted storage capacities, access to a storage facility by unauthorized persons, large amount of smoke generated in a room of the plant, lack of certain foodstuffs for planned meals. The analysis for identifying a trigger event can be based, for example, on artificial intelligence algorithms or on a simple comparison between acquired values and reference values or other algorithms.

Further, the auditor device is preferably configured to generate a first data set. The first data set is preferably stored as summarized data in databases or in files. Preferably, the data set is stored in a file format selected from the group comprising PDF, JSON, XML, CSV. PDF files are characterized by a high degree of universal usability on different data processing systems, while one of the great advantages of JSON files is the simplicity of implementation and use. Due to their simple structure, JSON files do not require a lot of resources during their use. Thus, large data can be evaluated in an acceptable time. The XML format can be advantageously linked to other systems without a high degree of complexity, so there is particularly good compatibility. XML is just as advantageously suitable for long-term file storage and XML can also be easily converted into other file formats. The CSV file format is advantageously versatile. The great advantage of the CSV format is furthermore its ease of transferability, such as for example importing into different databases or programs. In already existing databases, contents from CSV files can be input many times. It is particularly advantageous when different data sources (for example, data from different acquisition devices) are to be combined into a single data set.

In a preferred embodiment, sensor-specific raw data and/or prepared or processed raw data are transmitted by the acquisition device to the auditor device, which analyzes these data and stores an information value about plant-related process variables and/or a trigger event in the file formats specified above. Accordingly, it is possible that the auditor device receives an image file and converts it into abstracted information, an XML or CSV file. The advantage of this procedure is that the raw data and/or prepared or processed raw data of the acquisition devices are converted into a form which requires a much smaller storage capacity and in addition makes use of all the other advantages of the file formats specified above. The loss of information due to the abstraction does not cause any disadvantages in the further process sequences of the proposed invention.

The file formats to be used are not insignificant for the proposed system, because they have an influence on the calculation speed, the memory as well as the transmission speed. The interaction of the file formats with the auditor device, the report generator, the acquisition device and/or the signing device contribute, among other things, to the technical character of the invention. It has also been shown that in particular the plant-related process variables as well as an information value about a trigger event can be stored particularly well in aforementioned file formats without having to accept relevant information losses.

The report generator can assign a signing device to the first data set or determine a responsible signing device. Accordingly, the report generator preferably comprises means for generating, processing, storing, sending and receiving data. The assignment is made in particular on the basis of the information value about the trigger event included in the data set and/or on the basis of a process variable included in the first data set and/or on the basis of an evaluation of the information values and/or process variables received. In this context, the report generator preferably has access to a database comprising all signing devices with their addressing information. This database can either be arranged on an external server or be arranged in the structure of the report generator—i.e. in a memory—itself. Preferably, a responsible signing device is determined from the database for the information value of the first data set.

In addition, the report generator can preferably convert the files received from the auditor device into a file format that can be read specifically by the assigned signing device. This advantageously leads to the fact that signing devices can be configured respectively as different terminal devices with preferably differently readable file formats. For example, safety-relevant information, such as a fire that has broken out in the food processing plant, can be transmitted to a signing device that represents, for example, a control station for an emergency call system, with this control station receiving all the information received via a desktop PC. Simultaneously, the proposed system allows another entity, a responsible person/body (for example, the responsible cook), to receive this information, using a different terminal, for example, a smartphone.

In another preferred embodiment, the report generator is included in a server unit that is spatially separate from the auditor device and the workstation, with the report generator and the auditor device being in data communication with each other. The advantage of such an arrangement is, among other things, that the system is decentralized, so that in the event of failure of individual components, such as the report generator and/or the auditor device, the individual components can be replaced or repaired individually without having to replace the entire system. A report generator, which is arranged on a decentralized server, can advantageously be in data connection with several auditor devices of different systems, so that several systems according to the invention “share” the same report generator.

In another preferred embodiment, the report generator generates a request data set comprising a signature request and at least part of the first data set. The request data set is preferably stored in (and transmitted in) a format—corresponding to the associated signing device—that is compatible with the associated signing device. The assignment of the signing device to a data set can preferably be based on artificial intelligence algorithms or else on an assignment value or assignment information included in the first data set—introduced by the auditor device. In this context, the assignment is carried out in particular in the auditor device, wherein the report generator extracts the assignment value or the assignment information from the first data set and determines an addressing for a signing device and furthermore still creates a request data set. The request data set preferably exhibits a signature request over at least part of the first data set. The signature request may preferably be a measure of the relevance of the trigger event and/or the recorded plant-related process variables. Preferably, the more relevant or critical a piece of information, the greater the signature requirement.

Within the meaning of the invention, a signature is also to be understood as an electronic signature. Electronic signatures are preferably data linked to electronic information that can be used to identify a signer or signature creator and to verify the integrity of the signed electronic information. Usually, the electronic information is electronic documents. From a technical point of view, the electronic signature thus fulfills the same purpose as a handwritten signature on a paper document.

A digital signature is preferably generated by means of a cryptographic process in which a signer of an electronic document generates a message core (hash value) from the document using a corresponding algorithm and then encrypts this message core with their private key (for example with an asymmetric cryptographic process) to generate a digital signature. The digital signature can be stored or transmitted separately, but is then usually embedded in the document and transmitted together with the document. The recipient can also generate a message core (hash value) from the received document using the same algorithm and use the public key to verify the signature for authenticity. The cryptographic (mathematical) check against the key pair proves the origin (identity) of the signer and results in an equality of the message cores (hash values).

Digital signatures are preferably divided into three categories, namely “simple electronic signature”, “advanced electronic signature” and “qualified electronic signature”. The simple electronic signature preferably has no special requirements. Documents can be signed electronically without identity verification or consent. It is also considered a digital signature without specifying the author or sender. Examples of such a simple signature are as follows: PDF with scanned signature; signature on electronic terminals; e-mail with name. The advanced electronic signature, on the other hand, is already much more secure. It must meet strict identity verification requirements and consequently has a higher probative value than the simple signature. An advanced electronic signature is preferably created using a secret signature key that is uniquely and traceably linked to the signatory. The private signature key must be under the “sole control” of the holder. The signature creator is identifiable by attributes that must be verified by a certificate registration authority. The “qualified electronic signature” is preferably an electronic signature that is based on a qualified certificate that is valid at the time it is generated and that was created using a secure and trustworthy signature creation device—for example, a signature card or a combination of Signature Activation Module and HSM.

The report generator and the signing device preferably have means that can generate and/or read a message or a data set and/or file with a signature attached. This means that corresponding certificates and algorithms, as well as keys, are preferably available in a local infrastructure of the system components (the report generator and the signing device). Signatures of all three categories can be used here. Depending on the relevance of the trigger event and/or the acquired process variables, a high or low signature requirement can be assumed. The report generator can preferably make the decision of relevance itself by analysis, or this decision is determined by the auditor device, such that this information is transmitted to the report generator with the first data set. The relevance is preferably determined via artificial intelligence algorithms.

The report generator according to the invention has a number of advantages which were not yet known in this way in the prior art, especially in the context of a food processing plant. First, the report generator advantageously ensures that a “correct” signing device is selected for a specific trigger event and/or process variables. This ensures that information is transmitted exclusively to the relevant signing device, responsible bodies and/or persons. As a result, the information received can be immediately processed and signed by the signing device without having to forward the information under certain circumstances because the signing device is not responsible for this information. Furthermore, the report generator is preferably able to determine a specific relevance or prioritization for the information value about the trigger event and/or a process variable by generating a specific requirement data set for the information with a specific requirement for a security level and/or security chain.

In a preferred embodiment, the signing device is assigned to a body and/or person. For example, the body is a facility selected from the group comprising emergency call control center; hospital; authority (public order office, health office, employment office); logistics company; waste disposal company; different departments in a company which preferably operates the food processing plant (e.g. personnel department, management); supplier company. A person, for example, may work in one area of the aforementioned entities and/or perform activities directly related to the food processing facility, such as a cook, service personnel for guests, or a cleaner. For example, in the event of component failure or the need for technician intervention, a customer may be given the opportunity to directly place a legally binding order using the signature process described.

Preferably, the information about a trigger event and/or process variables reaches one of the above-mentioned bodies and/or persons responsible for this information. The signing device is preferably configured as a terminal device, selected from the group comprising: smartphone, tablet PC, desktop PC, notebook, pager, Internet-capable multimedia device. Preferably, the terminal device is an internet-capable data processing unit, which is adapted to directly display the information visually and/or acoustically. As explained at the outset, the signing device or the terminal device can generate an electronic signature for at least part of the requirement data set. For this purpose, the signing device preferably has means which make such a signature possible.

Hereby, certificates, means for encryption in local data may be included on the terminal device. In alternative embodiments, however, it may also be preferred that the signing device accesses an external server, such as a cloud, in order to be able to generate a signature.

In another preferred embodiment, the system is characterized in that the report generator is adapted to,
transmit the response data set to the auditor device and/or to another signing device and/or store the response data set and the requirement data set;
in case of a missing response by a response data set, to assign another signing device to the first data set after a defined time interval.

Accordingly, the system according to the invention preferably claims a signature process for information deemed relevant by the system. As a result of the report generator storing the response data set as well as the requirement data set, the described signature process advantageously enables legally compliant archiving of all processes. If the report generator is arranged on an external server (and/or at least the storage of the data takes place on an external server, such as a cloud), subsequent access by various—in particular a plurality of—entities is made possible. Preferably, the report generator takes over the monitoring of the progress in the signature chain, so that alternative signature options can also be determined in case of lack of progress in a defined time interval. In addition, the report generator is accompanied by the advantage of ensuring in each case that relevant information about the trigger event and/or process variables reaches a responsible signing device. Even if a signing device does not transmit any feedback, i.e. no response data record to the report generator, a further signing device is preferably assigned to the first data set after a predefined time (time interval). While the further signing device is not the first assignment choice, it may be assigned with respect to a body and/or person having a shared responsibility (accountability) in the context of the trigger event or process variables.

In a preferred embodiment, the report generator assigns the first data set to a further signing device if it does not receive a response from the first assigned signing device in a time interval of preferably 1 min to 48 h, more preferably 10 min to 24 h, particularly strongly preferably 15 min to 5 h, in particular 30 min to 2 h. The report generator then assigns the first data set to the second signing device, i.e. if the report generator does not receive a response data set after the specified time interval. The predefined time interval is preferably to be (re)determined or varied according to the relevance of the trigger event and/or the plant-related process variables. By means of artificial intelligence methods, time specifications for a release of alternative process steps (in the case of the example, the release of reserve flour from the freezer) can be derived from the plurality of the present linked process variables, as already explained by way of the example with the missing flour, which then provide the respective suitable preferred assigned time intervals for a required feedback from a signing device. In this way, information about the release event and/or the plant-related process variables is routed to a responsible body and/or person respectively, whereby it can advantageously be ensured that this information has actually been read/processed. It has been shown that the described time intervals determined in this way are particularly well suited for the system according to the invention.

In another preferred embodiment, the system is characterized in that the signature requirement is dependent on the trigger event and/or is a requirement with respect to:
a) a signature level comprising a security level and/or
b) a signature chain comprising a requirement for a signature from at least two signing devices.

By means of the signature requirement, the report generator can advantageously already make a corresponding specification from its point of view with regard to the minimum security level of the requested signature required, which can then be processed automatically without further intervention or further input in this respect by the signing device (or the assigned bodies and/or persons). This can considerably accelerate and simplify the signature process. This is highly advantageous for user acceptance and implementation of such a procedure in the legally compliant documentation of health-relevant and safety-relevant process events in a food processing plant.

In principle, it can be provided that the signing device can also disregard the specification of the report generator if necessary, i.e. can also generate a response data set with a signature with a lower security level (than the specified minimum security level). Preferably, however, it is provided that the signing device can generate the response data set only if an electronic signature has been generated over at least part of the requirement data set in accordance with the signature specification. Additionally or alternatively, it can be provided that the response data set is only made available to the report generator if an electronic signature of the signing device has been generated over at least part of the requirement data set in accordance with the signature specification. This can ensure that it is immediately recognized that the signature process has failed.

In another preferred embodiment, the report generator can also be configured as a signature device, so that when a requirement data record is created, it is signed by the report generator. The report generator selects a preferred security level for its signature. In particular, this need not correspond to the requested security level. In further preferred embodiments, the security level of the report generator signature may define the requested security level. In particular, this may apply if the report generator does not specify a different preference with respect to the requested security level. Hereby, a particularly fast and smooth processing is possible.

Within the meaning of the invention, the signature level is preferably a security level, whereby the security level preferably defines the type of signature. This is preferably to be divided into the above-mentioned three categories, namely “simple electronic signature”, “advanced electronic signature” and “qualified electronic signature”.

A signature chain is preferably to be understood as a signature sequence in which an electronic document or a first data set or a requirement data set is first signed by a first signing device and then passed to a further signing device (or several further signing devices), which also sign the electronic document or the first data set or the requirement data set and finally transmit it to the report generator as a response data set. In effect, the requirement for a signature chain is preferably a requirement for multiple signatures by multiple signing devices. It may be preferred that after each signature, the signing device generates and transmits a response data set to the report generator, which then forwards this response data set to one or more additional signing devices. The signature chain makes it possible to inform several responsible bodies/persons simultaneously or in quick succession for extremely critical information. In addition, the signature chain can make the response to the critical information more secure, since, for example, two or more signatures are required for a system stop (signature of one signing device would not be sufficient).

The signature process can therefore be multi-stage, so that, for example depending on the severity of the event, the supervisor must also sign in addition to the person responsible. Furthermore, different signature qualities, i.e., different defined security levels of the signatures, can be selected, starting with simple information via a “simple electronic signature” via an “advanced electronic signature” further via a “qualified electronic signature”. In addition, branching in the signature cycle, delegation in the case of absence and also group addressing are possible, whereby it can be specified that a certain minimum number of persons from a group must sign.

In a further preferred embodiment, the system is characterized in that the response data set comprises a second data set in which data are comprised on the basis of which the auditor device can initiate a continuation or an abort with regard to the execution of a process of the workstation. Advantageously, this results in the ability to respond to particular occurrences in the food processing facility, such response being initiated from a location which is remote from the facility. The design of the system makes it possible to react very quickly in particular. Furthermore, such a system offers advantages in terms of efficiency and cost-effectiveness, because instructions and/or maintenance from a remote location can, for example, eliminate the need for travel by people. Furthermore, several instructions can be provided simultaneously to the auditor device.

In another preferred embodiment, the system is characterized in that the system comprises an action device, the action device being adapted to,
create and add the second data set to the response data set and then transmit the response data set to the auditor evice
wherein the action device is in data communication with the report generator and/or the signing device and/or the auditor device.

This can result in direct feedback to the IoT system via the report generator or the action device, e.g. a system stop can be initiated in the event of safety-relevant incidents. Inclusion of an action device can further lead to increased safety of the system. The provision of information with repercussions on the food processing plant by the second data set should be carried out under strict conditions. The action device can be particularly well secured and resistant to manipulation as a single system component.

Preferably, the second data set comprises data in the context of the control and/or regulation of the food processing system, in particular of the workstations included in the system. The auditor device is thereby configured to implement and execute the control and/or regulation commands included in the second data set.

In a preferred embodiment, the action device comprises means for generating, processing, storing, transmitting and receiving data. In this regard, the action device receives a response data set from a signing device and may add a second data set to the response data set. Preferably, the action device and the signing device may be comprised on a common terminal device or more preferably may be separate from each other as stand-alone devices. It is also preferred that the response data set is transmitted to the action device with a signature. The action device is thereby able to read or verify the signature. It then adds a second data set to the response data set and transmits the response data set in a direct manner to the auditor device and/or the report generator. Further, it may be preferred that the response data set which the action device receives from the signing device does not yet include a signature, such that the action device would transmit the response data set back to the signing device after adding the second data set. The signing device, in turn, would only subsequently add a signature to the response data set and transmit it to the report generator.

In a preferred embodiment, the action device creates a second data set based on input data from a responsible person/body. In this context, the action device preferably has means by which a responsible person/body can generate an input with a command. In a preferred embodiment, however, the action device generates a second data set preferably automatically with the aid of artificial intelligence algorithms.

In a further preferred embodiment, the system is characterized in that the report generator is arranged on a server and/or the report generator comprises evaluation applications, the evaluation applications being adapted to analyze the information values comprised in the first data set and/or acquired process variables. Advantageously, the evaluation applications enable the relevance of the information values and/or acquired process variables to be recognized and, as a result, the best possible signing device to be assigned to the first data set. Particularly strongly preferred, the evaluation applications feature artificial intelligence algorithms. As already described, there are also advantages associated with having the report generator on a server. For example, multiple systems can share a report generator. The report generator can be maintained and adjusted remotely. Furthermore, such an arrangement of the report generator on a server entails the fact that the report generator does not have to be included in the food processing plant itself, so that this again does not take up space in the plant.

In a further preferred embodiment, the system is characterized in that the transmission of the requirement data set, response data record, first data set and/or second data set takes place as a data transmission process via IP-based communication, with at least one data transmission process being cryptographically secured by a security module. This leads particularly advantageously to tamper-proof documentation of all signature and information processes.

IP-based communication is preferably carried out via Internet protocols, i.e. network communication protocols. The transmission of data via network communication protocols advantageously enables a transmission of large amounts of data, so that under certain circumstances even the live transmission of video and detailed photo sequences are made possible. Furthermore, such a transmission enables remote control of components such as camera and/or microphone. The protocols are selected from the group comprising https, http POST, SIP, SFTP, FTP, SMTP.

In a preferred embodiment, the “http POST” protocol is used as the transmission protocol. In this context, the first data set and/or the requirement data set and/or the response data set are transmitted as a so-called payload using “http POST”. The advantage of “http POST” is that the entities are not burdened with having to maintain a connection for an extended period of time. Furthermore, “http POST” can be implemented in the system according to the invention in a simple manner without great demands and is in particular extremely user-friendly.

In a further preferred embodiment, the “SFTP” protocol is used as the transmission protocol. A significant advantage of “SFTP” is that communication is encrypted. This means that attackers cannot easily view the data traffic. The encryption is not provided by “SFTP” itself, but by the underlying communication channel, which is why various methods can be used. In addition to copying files in both directions—from a client to a server and vice versa—“SFTP” can also be used to read out and list directories and delete files on the client server.

In a further preferred embodiment, an SFTP server is preferably interposed between the individual system components, i.e. the auditor device, the action device and/or the report generator, when transferring data using an “SFTP” protocol. In this preferred embodiment, SFTP files are exchanged between a first system component and the SFTP server, with the SFTP server then converting these files and making them available to the second system component via an “http POST” protocol.

In addition, the preferred use of a security module that cryptographically secures all data transmission processes makes the proposed system particularly secure against data manipulation, data theft and/or data loss. Preferably, the security module is configured as an HSM. It is preferred within the meaning of the invention that the HSM is a hardware-based cryptographic module that preferably has FIPS 140-2 certification. By providing auditor device, report generator, action device and/or signing device operating with FIPS certification, in particular a technical problem is solved by technical means, namely the provision of particularly secure data transmission within the system. The HSM may be formed by or comprise a single chip module, an autonomous multichip module or an embedded multichip module. Preferably, the HSM is adapted to store data in a particularly secure manner. In particular, an HSM is capable of generating, storing, using, and/or maintaining critical security parameters, such as passwords, confidential data, or keys for encrypting data. For example, the keys may be symmetric or asymmetric. Advantageously, HSMs may be used as cryptographic coprocessors. In preferred embodiments, an HSM may include battery-powered circuitry and/or voltage monitoring. In particular, this allows for the integration or provision of a real-time clock for proper timekeeping and time stamping, which can ensure, for example, that expired keys can no longer be used. In addition, an HSM can include redundant memory, which can be used, for example, to simultaneously use multiple technologies to generate additional data security. In particular, the HSM can be used to implement a public key infrastructure at the highest level, as is known to the person skilled in the art.

The fact that the system components are preferably equipped with a security module means that all data transmission processes can be cryptographically secured. Particularly advantageously, this makes the system resistant to manipulation and unauthorized reading of the data.

It is within the meaning of the invention that an HSM comprises a chain of certificates that are preferably loaded onto the device before the HSM is put into operation. The HSM is further adapted to generate its own private and public device keys. Preferably, the private key does not leave the HSM at any time, while the public key can be delivered externally, for example to a decentralized server for signing there. In return, the HSM can receive a personalized, signed device certificate that allows the HSM to significantly increase security in an Internet of Things (IOT) system. The HSM can then be recognized and authenticated by the decentralized server as a “real” security device, which is made possible in particular by assigning a unique identifier. In this way, authenticated TLS connections can be established in a particularly uncomplicated manner (Transport Layer Security).

In another preferred embodiment, the system is characterized in that the first and/or second data set comprises data selected from the group comprising location data, personal data, time-related data, audio data, image data, analysis data, process data, usage data, text data, and/or video data,
wherein the information value about a trigger event in a first data set comprises quality-related and/or quantity-related information about the trigger event and/or an action option for a response to the trigger event;
wherein the second data set comprises an information value about an action, the action having an acknowledgement, enablement, and/or cancellation of the execution of a process of the workstation.

The listed data can comprise far-reaching information about the food processing plant so that further information, such as a trigger event, can be derived from it. In addition to identifying a trigger event, the data is also suitable for monitoring processes and/or workstations as such.

Quality-related information about a trigger event preferably includes information about the nature, severity, scope, and/or relevance of an event that has occurred.

Quality-related information about an action option is preferably information that suggests, for example, the nature of a response or action to the trigger event. For example, an action option may include suggesting the deployment of a technician, a delivery of a food product, and/or a deployment of a rescue unit (e.g., fire department). Information about an action option enables the signing device or its assigned responsible body and/or person to offer one or more suggestions for a further course of action, in particular a response. The options for action are preferably sufficiently developed that they can be followed without further considerations or calculations and the signing device and/or the action device preferably generate a command (response data set and/or second data set), which comprises an action selected from these options for action.

Quantity-related information, on the other hand, preferably comprises information about a number of events and/or costs. Accordingly, a provision of quantity-related information about an action option includes information about quantitative and or numerical characteristics.

In another preferred embodiment, the system is characterized in that the workstation is selected from the group comprising: cooling means, cooking means, storage means, analysis means, labeling means, air conditioning means, processing means, modification means, transport means, cleaning means, water supply means, extraction means, disposal means. In particular, the aforementioned workstations are found in a food processing plant and require monitoring, because they are essential for the processing, preferably preparation, of food. The workstation according to the invention is not limited to the workstations included in the mentioned group.

In another preferred embodiment, the system is characterized in that the workstation generates plant-related process variables selected from the group comprising cooling or cooking temperatures, storage quantities, storage time, water quantity, waste quantity, air humidity, weight, cooling or cooking time, processing time, delivery quantity, air particle quantity, air quality, analysis and/or identification values of the processed substances. In particular, the combination of the above process variables can produce a comprehensive picture of the food processing plant. It is understood that the invention is not limited to this enumeration of process variables.

In a further preferred embodiment, the system is characterized in that the analysis of the recorded process variables is performed via artificial intelligence algorithms. The use of artificial intelligence (AI for short) to analyze data entails significant advantages over analysis by conventional (computer-implemented) methods and/or also over manual analysis by a human observer. Thus, an AI can advantageously analyze extremely large amounts of data in a very short time in an automated manner. Furthermore, AI algorithms can recognize patterns and/or features in a data set that are not recognized by a human or conventional algorithms. In particular, this means that the AI can recognize trigger events occurring at an early stage (well before the actual occurrence of the trigger event).

In a further preferred embodiment, the artificial intelligence algorithms preferably comprise machine learning algorithms. It is understood that machine learning algorithms are a subfield of artificial intelligence. Machine learning uses mathematical and statistical models to “learn” from data sets. In general, machine learning algorithms have the advantage that information that is too complex for a human observer can be automatically extracted from a large data set. There are a variety of machine learning algorithms that can be broadly categorized into three different learning methods: supervised learning, unsupervised learning, and reinforcement learning.

In accordance with the invention, supervised learning methods are particularly preferred for analyzing the recorded plant-related process variables. In the supervised learning method, a so-called training process is first carried out. Here, training data is provided in the form of input data together with the corresponding target data. Generally, in machine learning methods, the purpose of training is to adjust parameters of a function so that the function is subsequently able to determine the target value with high accuracy from the corresponding input value. The adjusted function is then used after the training process to predict target data for previously unseen input data. The function is described by a mathematical and/or statistical model.

In a preferred embodiment, the function is configured using support vector machines, Bayesian networks and/or decision trees. Particularly preferably, the function is described by an artificial neural network. In accordance with the invention, the artificial neural networks can have different architectures and be designed, for example, as Deep Feed Forward (DFF) Network, Recurrent Neural Network (RNN), Deep Convolutional Network (DCN), Deconvolutional Network (DN), Convolutional Neural Network (CNN), Deep Residual Network (DRN), Boltzmann Machine, Time Delay Neural Networks (TDNNs).

Within the meaning of the invention, the input data are preferably defined by the plant-related process variables, namely preferably cooling or cooking temperatures, storage quantities, storage time, water quantity, waste quantity, humidity, weight, cooling or cooking time, processing time, delivery quantity, air particle quantity, air quality, analysis and/or identification values of the processed substances (without being limited to these).

According to the invention, target data are preferably defined by the classification of the input data into a specific class and/or the occurrence of specific target data (events) is determined on the basis of the input data. Likewise, probabilities for belonging to a specific class can also be output as target data or probabilities for an occurrence of specific target data (events). Preferably, the classes are divided into specific trigger events. For example, “failure of a refrigeration unit”; “fire in the plant”; “overheating of food in cooking processes”; “no storage capacity”; “unauthorized persons have gained access to the warehouse”. Accordingly, as a so-called classification algorithm, the AI can output whether a certain trigger event occurs based on the assignment of the input data into corresponding target data.

Equally preferably, a machine learning algorithm can use as input (input data) the trigger event determined in a previous step. Accordingly, the machine learning algorithm can determine a signing device responsible for the trigger event as output (target data).

In another preferred embodiment, the unsupervised learning method is used to analyze or process the plant-related process variables. In unsupervised learning, the algorithm attempts to detect patterns in the input data that deviate from structureless background noise. The function in the training process is guided only by the similarities in the input data and adjusts its parameters accordingly, such that no output data is used for the training process.

In a preferred embodiment, the unsupervised learning method is used to perform segmentation or clustering of the input data or, preferably, compression of the input data. The person skilled in the art is familiar with the terms clustering, segmentation and compression in connection with machine learning methods.

In a preferred embodiment, the unsupervised learning algorithm preferably comprises Principal Component Analysis (PCA) and/or the K-Means algorithm and/or at least one neural network.

The proposed system further preferably features artificial intelligence algorithms with unsupervised learning methods. In this context, a data set of acquired plant-related process variables can be pre-processed via unsupervised learning methods, for example by grouping (clustering) relevant data in order to subsequently obtain a classification algorithm for determining a trigger event and/or a signing device based on this “filtered” data.

As already described, in both methods mentioned above, so-called training processes are carried out in a first step to determine optimal parameters of an above-mentioned machine learning function. Based on the adapted function, various statements are made after the training for previously unknown input data.

In another preferred embodiment, the reinforcement learning method is used for analyzing or processing the auditing information. In the reinforcement learning method, on the other hand, the training process takes place continuously even after the parameters of a function have been adjusted. Via “trial and error”, effects of various statements are observed and evaluated using the adjusted function for previously unknown input data. In response to these statements, the algorithm receives feedback, represented abstractly in the form of a reward or punishment.

Whereupon the algorithm further optimizes the function based on its parameters. Accordingly, the algorithm continuously adapts or modifies the function of the machine learning process.

In a preferred embodiment, the reinforcement learning method comprises the Q-learning method and/or aforementioned neural networks and/or further neural networks as well as further algorithms known to the person skilled in the art.

In a further preferred embodiment, the invention relates to a method for legally compliant documentation of process events relevant to health and safety in a food processing plant comprising the following steps:
a. automated recording of plant-related process variables by an acquisition device
b. identification of a trigger event by an auditor device;
c. transmitting a first data set to a report generator, the data set comprising at least one of the recorded process variables and/or an information value about the trigger event;
d. determining a signing device responsible for the first data set on the basis of the information value about the trigger event included in the data set and/or on the basis of a process variable included in the first data set and/or on the basis of an evaluation of the information values and/or process variables obtained;
e. transmission by the report generator of a requirement data set to the first signing device associated with the first data set, the requirement data set comprising a signature request and at least part of the first data set;
f. generation of a response data set by the signing device, the response data set comprising an electronic signature for at least part of the requirement data set

The combination of the present process steps leads to a surprising synergistic effect, which results in the advantageous features and the associated overall success of the invention, whereby the individual features interact with each other. An important advantage of the process according to the invention is the need for extremely few process steps and system components, while nevertheless generating an extremely secure infrastructure for legally compliant documentation of health-relevant and safety-relevant process events in a food processing plant.

A person skilled in the art recognizes that the advantages, technical effects and preferred embodiments discussed in the context of the system according to the invention apply analogously to the method according to the invention for legally compliant documentation of process events relevant to health and safety in a food processing plant, which makes use of the system according to the invention. Likewise, all advantages, technical effects and preferred embodiments described in the context of the method are transferable to the system.

In a further preferred embodiment, the method is characterized in that the response data set is transmitted to the report generator and/or a further signing device and/or an action device, the further signing device adding a further electronic signature to the requirement data set and/or the action device creating a second data set and adding it to the response data set. This advantageously enables the application of a signature chain, which ensures increased security of a signature, because in certain cases a process in the food processing plant can, for example, only be continued or aborted if several signing devices have received and signed the information about a trigger event.

In a further preferred embodiment, the method is characterized in that the report generator assigns a further signing device to the first data set if the response data set is not transmitted after a specified time interval. This advantageously ensures that the information about a trigger event and/or the process variables as such reach a signing device, even if a first responsible signing device may be impeded (e.g. by power failure).

In a further preferred embodiment, the method is characterized in that the auditor device initiates an abort of a process based on the data included in the second data set. The fact that the auditor device can preferably initiate an abort of processes makes it advantageously possible to control or regulate the system for processing foodstuffs remotely.

In a further preferred embodiment, the method is characterized in that the plant-related process variables and/or information values are analyzed via artificial intelligence algorithms, whereby the trigger event is recognized and/or an option for action on the trigger event is determined. The use of artificial intelligence in the method according to the invention leads to an optimization of processes and an elimination of repetitive tasks, so that efficiency can be increased through more targeted and thus more sustainable use of resources, time savings and minimization of waste.

### FIGURES

In the following, the invention will be explained in more detail with reference to figures, without being limited to them.

### SHORT DESCRIPTION OF THE IMAGES

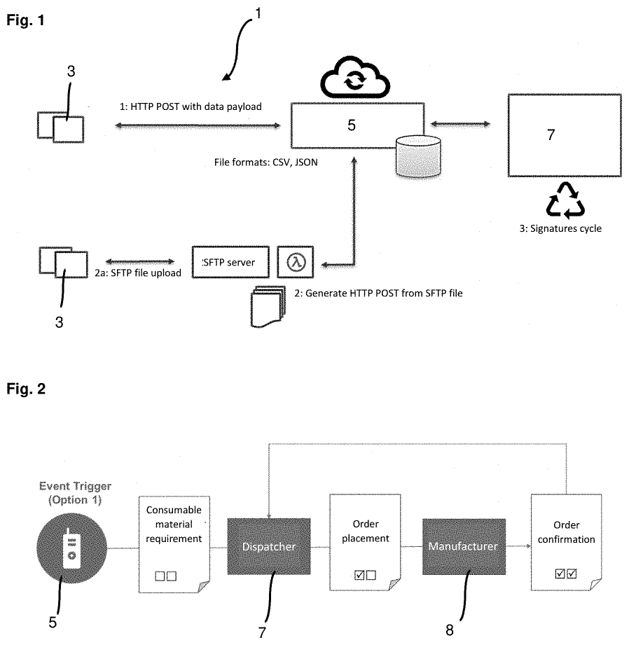

FIG. 1 Schematic representation of a preferred arrangement of the system according to the invention

FIG. 2 Schematically illustrated sequence of a preferred embodiment of the process according to the invention

### DETAILED DESCRIPTION OF THE IMAGES

FIG. 1 illustrates a preferred arrangement of system components for a system 1 for legally compliant documentation of process events relevant to health and safety. The system 1 preferably comprises a workstation, an acquisition device, an auditor device 3, a report generator 5 and a signing device 7. The acquisition device is preferably assigned to the workstation and preferably automatically acquires plant-related process variables. These are preferably transmitted to the auditor device 3, which analyzes the acquired process variables and identifies a trigger event. In a first scenario, the auditor device 3 can preferably generate a first data set, and transmit this to the report generator 5 via a direct connection. Preferably, the report generator 5 is arranged on a server. In this case, the transmission of the data to the report generator 5 preferably takes place via the network protocol “http POST”, with the relevant data preferably being transmitted as a payload in a CSV or JSON file format. In a second alternative scenario, an SFTP server is preferably interposed between the report generator 5 and the auditor device 3. In this case, the auditor device 3 preferably performs an SFTP file upload to the SFTP server, wherein the files or data files comprise a first data set containing relevant information about the trigger event and/or the process variables per se. The SFTP server is preferably capable of converting the SFTP file into a CSV or JSON file format and transmitting the same to the report generator 5 as a payload using network protocol “http POST”. The report generator 5 is preferably configured to assign a responsible signing device 7 to the received files or information. Here, the report generator 5 preferably has a database with the addressing information of all signing facilities 7. After an assignment, a requirement data set is preferably created by the report generator 5, which has a requirement for a signature level and signature chain. The signing device 7 is preferably adapted to generate a response data set comprising an electronic signature for at least part of the requirement data set. Subsequently, the response data set is preferably transmitted to the report generator 5. The report generator 5 can preferably store it so that the signature is documented and/or the report generator 5 forwards the response data set to the auditor device 3 so that it receives confirmation that its transmitted information has been acknowledged by responsible entities. Preferably, this can be done via a direct connection between report generator 5 and auditor 3 or with an intermediate SFTP server.

FIG. 2 shows a schematic representation of a preferred embodiment of the method according to the invention. As already explained in FIG. 1, the report generator 5 preferably receives information about a trigger event from an auditor device 3 (not shown in FIG. 2) on the basis of a first data set. The report generator 5 then preferably determines a responsible signing device 7 (here: dispatcher) and assigns the first data set to it. Furthermore, the report generator 5 preferably creates a requirement data set with a requirement for a signature level and signature chain and transmits this requirement data set to the assigned signing device 7. In the present case, the signature chain requires the signature of two signing devices 7,8. The signing device 7 preferably creates a response data set after receiving the requirement data set, the response data set comprising an electronic signature for at least part of the requirement data set. Finally, the signing device 7 transmits the response data set to a further signing device 8 (here: manufacturer). The further signing device 8 also creates a response data set with an electronic signature for at least part of the requirement data set.

### REFERENCE LIST

1 System for legally compliant documentation of health-relevant and safety-relevant process events
3 Auditor device
5 Report generator
7 Signing device
8 Further signing device

1. System (1) for legally compliant documentation of health-relevant and safety-relevant process events in a food processing plant, the system comprising at least a workstation, a acquisition device, an auditor device (3), a report generator (5) and a signing device (7), characterized in that
a) the acquisition device is assigned to the workstation and is adapted to automatically acquire plant-related process variables;
b) the auditor device (3) is adapted to
(i) analyze the acquired process variables and identify a trigger event;
(ii) generate a first data set, the first data set comprising at least one of the acquired process variables and/or an information value about the trigger event;
(iii) submit the first data set to the report generator;
c) the report generator (5) is adapted to
(i) determine a signing device responsible for the first data set, the responsible signing device being determined on the basis of the information value about the trigger event contained in the data set and/or on the basis of a process variable included in the first data set and/or on the basis of an evaluation of the obtained information values and/or process variables;
(ii) transmit a requirement data set to the signing device assigned to the first data set, the requirement data set comprising a signature requirement and at least part of the first data set;
d) the signing device (7) is adapted to
(i) generate a response data set comprising an electronic signature for at least part of the requirement data set.

2. System (1) according to claim 1
characterized in that
the report generator (5) is adapted to
transmit the response data set to the auditor device (3) and/or to a further signing device (8) and/or store the response data set and the requirement data set;
assign a further signing device (8) to the first data set after a defined time interval in the event of a missing response via a response data set.

3. System (1) according to claim 1
characterized in that
the signature requirement is dependent on the trigger event and/or is a requirement with respect to:
a) a signature level comprising a security level and/or
b) a signature chain comprising a requirement for a signature from at least two signing devices.

4. System (1) according to claim 1
characterized in that
the response data set comprises a second data set in which data are comprised on the basis of which the auditor device (3) can initiate a continuation or an abort of the execution of a process of the workstation.

5. System (1) according to claim 4
characterized in that
the system (1) comprises an action device, the action device being adapted to
create and add the second data set to the response data set and then transmit the response data set to the auditor device (3)
wherein the action device is in data communication with the report generator (5) and/or the signing device (7) and/or the auditor device (3).

6. System (1) according to claim 1
characterized in that
the report generator (5) is arranged on a server and/or the report generator (5) comprises evaluation applications, the evaluation applications being adapted to analyze the information values comprised in the first data set and/or acquired process variables.

7. System (1) according to claim 1
characterized in that
the transmission of the requirement data set, response data set, first data set and/or second data set is carried out as a data transmission process via IP-based communication, at least one data transmission process being carried out in a cryptographically secured manner by a security module.

8. System (1) according to claim 1
characterized in that
the first and/or second data set comprises data selected from the group comprising location data, personal data, time-related data, audio data, image data, analysis data, process data, usage data, text data and/or video data,
wherein the information value about a trigger event in a first data set comprises quality-related and/or quantity-related information about the trigger event and/or an action option for a response to the trigger event;
wherein the second data set comprises an information value about an action, the action being an acknowledgement, enablement and/or cancellation of the execution of a process of the workstation.

9. System (1) according to claim 1
characterized in that
the workstation is selected from the group comprising: cooling means, cooking means, storage means, analyzing means, modification means, labeling means, air conditioning means, processing means, transport means, cleaning means, water supply means, extraction means, disposal means.

10. System (1) according to claim 1
characterized in that
the workstation generates plant-related process variables selected from the group comprising cooling or cooking temperatures, storage quantities, storage time, water quantity, waste quantity, air humidity, weight, cooling or cooking time, processing time, delivery quantity, air particle quantity, air quality, analysis and/or identification values of the processed substances.

11. System (1) according to claim 1
characterized in that
the analysis of the recorded process variables is carried out via artificial intelligence algorithms.

12. Method for legally compliant documentation of health-relevant and safety-relevant process events in a food processing plant comprising the following steps:
a. automated acquisition of plant-related process variables by an acquisition device
b. identification of a trigger event by an auditor device (3);
c. transmission of a first data set to a report generator (5), the data set comprising at least one of the acquired process variables and/or an information value about the trigger event;
d. determining a signing device (7) responsible for the first data set on the basis of the information value about the trigger event included in the data set and/or on the basis of a process variable included in the first data set and/or on the basis of an evaluation of the obtained information values and/or process variables;
e. transmission of a requirement data set to the first signing device (7) assigned to the first data set by the report generator (5), the requirement data set comprising a signature request and at least part of the first data set;
f. generation of a response data set by the signing device (7), wherein the response data set comprises an electronic signature for at least part of the requirement data set

13. Method according to claim 12
characterized in that
the response data set is transmitted to the report generator (5) and/or a further signing device (8) and/or an action device, wherein the further signing device (8) adds a further electronic signature to the requirement data set and/or the action device creates a second data set and adds it to the requirement data set.

14. Method according to claim 12
characterized in that
the report generator (5) assigns a further signing device (8) to the first data set if the response data set is not transmitted after a specified time interval.

15. Method according to claim 12
characterized in that
the auditor device (3) initiates an abort of a process based on the data included in the second data set.

16. Method according to claim 12
characterized in that
the plant-related process variables and/or information values are analyzed via artificial intelligence algorithms, whereby the trigger event is identified and/or an action option is determined for a response to the trigger event.
